(19) United States
(12) Patent Application Publication
(10) Pub. No.: US 2016/0204491 A1
(43) Pub. Date: Jul. 14, 2016

(54) ZINC-AIR BATTERY SYSTEMS AND METHODS

(71) Applicant: Revolution Power Inc., Seattle, WA (US)

(72) Inventors: Chris Ashfield, Seattle, WA (US); Thomas Lehman, Seattle, WA (US); Dan Shaw, Seattle, WA (US); Kate Alspaugh, Seattle, WA (US); James O'Malley, Seattle, WA (US)

(21) Appl. No.: 14/991,222

(22) Filed: Jan. 8, 2016

Related U.S. Application Data
(60) Provisional application No. 62/101,309, filed on Jan. 8, 2015.

(51) Int. Cl. H01M 12/08; H01M 2/02

(52) U.S. Cl. CPC H01M 12/08; H01M 2/026; H01M 2220/30; H01M 2002/0297

(57) ABSTRACT

One aspect includes a zinc-air battery that includes a gas-permeable barrier sheet first layer, a cathode collector second layer disposed facing the gas-permeable barrier sheet first layer, a cathode puck third layer disposed facing the cathode collector second layer, a separator fourth layer disposed facing the cathode puck third layer, a zinc fifth layer disposed facing the separator fourth layer, an anode collector sixth layer disposed facing the zinc fifth layer; and a housing surrounding at least the first, second, third, fourth, and fifth layers and comprising a gas-permeable housing first end disposed facing the barrier sheet first layer.

### CROSS-REFERENCE TO RELATED APPLICATIONS

This application is a non-provisional of and claims the benefit of U.S. Provisional Application No. 62/101,309, filed Jan. 8, 2015, entitled Zinc-Air Battery Systems and Methods. This application is hereby incorporated herein by reference in its entirety and for all purposes.

### BRIEF DESCRIPTION OF THE DRAWINGS

FIG. 1a is an exemplary perspective drawing illustrating an embodiment of a battery.

FIG. 1b is an exemplary perspective drawing illustrating the battery of FIG. 1a coupled to a smartphone.

FIG. 2a is an exemplary perspective drawing illustrating the battery of FIGS. 1a and 1b associated with an adapter.

FIG. 2b is an exemplary perspective drawing illustrating the battery of FIGS. 1a, 1b and 2a coupled with the adapter of FIG. 2a and associated with a power cord.

FIG. 3a illustrates an exploded perspective view of a battery in accordance with another embodiment.

FIG. 3b illustrates a perspective view of the battery of FIG. 3a in an assembled configuration.

FIG. 4a illustrates a perspective view of a frame of the battery of FIGS. 3a and 3b.

FIG. 4b illustrates a cross-section perspective view of the frame of FIG. 4a.

FIG. 5a illustrates a perspective view of a barrier of the battery of FIGS. 3a and 3b.

FIG. 5b illustrates a cross-section perspective view of the barrier of FIG. 5a.

FIG. 6 illustrates a perspective view of the barrier and frame of FIGS. 4a and 4b.

FIG. 7a illustrates a perspective view of a cathode of the battery of FIGS. 3a and 3b.

FIG. 7b illustrates a cross-section perspective view of the cathode of FIG. 7a.

FIG. 8a illustrates an exploded perspective view of a zinc layer, anode collector and can of the battery of FIGS. 3a and 3b.

FIG. 8b illustrates a perspective view of the zinc layer, anode collector and can of FIG. 8a in an assembled configuration.

FIG. 9 illustrates an exploded perspective view of a battery in accordance with a further embodiment.

FIG. 10 illustrates a perspective view of the battery of FIG. 9 in an assembled configuration.

FIG. 11 illustrates a cross sectional side view of the batteries of FIGS. 9 and 10.

FIG. 12 illustrates a cross sectional perspective view of an anode cap of the battery of FIGS. 9, 10 and 11.

FIG. 13 illustrates an exploded perspective view of a battery in accordance with another embodiment.

FIG. 14a illustrates a perspective view of the battery of FIG. 13 in an assembled configuration.

FIG. 14b illustrates a cut-away perspective view of the battery of FIGS. 13 and 14a.

FIG. 15 illustrates an exploded perspective view of a battery in accordance yet another embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

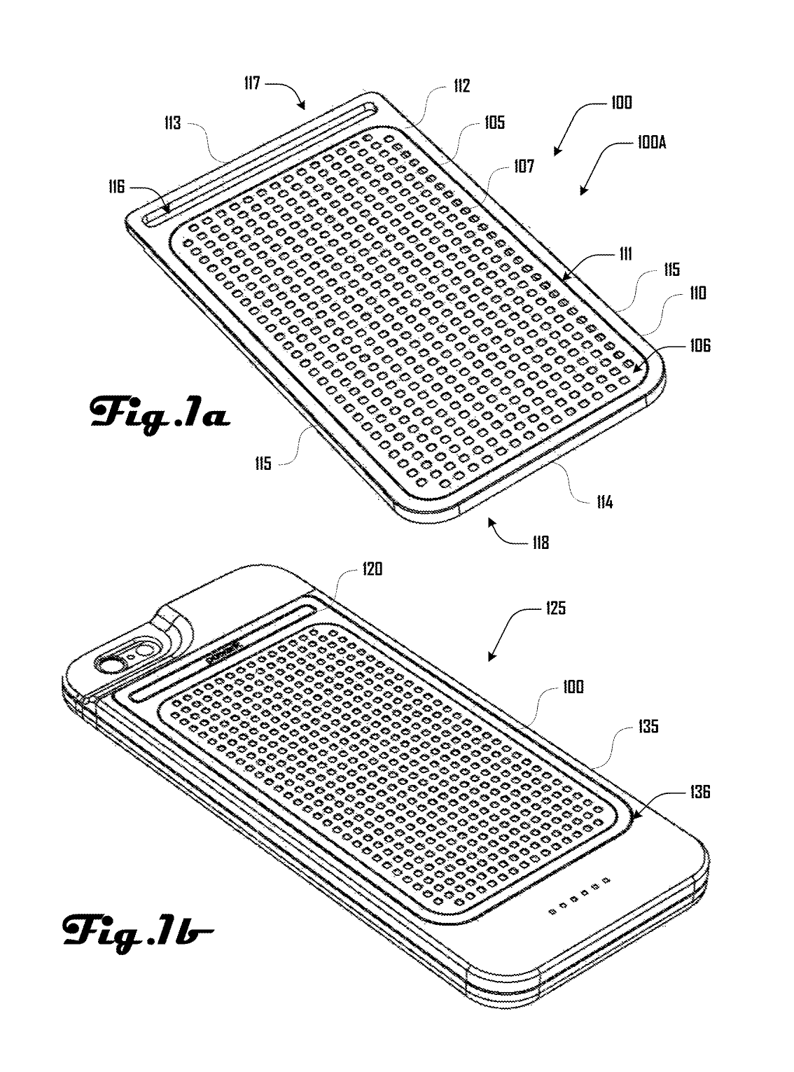

Turning to FIG. 1a, a battery 100 is shown in one example embodiment 100A as comprising battery body 105 disposed in a cartridge 110. The battery body 105 is shown having a face 106 comprising a plurality of vents 107. The battery body 105 is disposed in a tray 111 defined by the cartridge 110, which further defines a rim 112 that peripherally surrounds the face 106 of the battery body 105 on cartridge top and bottom ends 113, 114 and cartridge sides 115. The cartridge top end 113 comprises an elongated coupling slot 116 defined by the cartridge 110 that extends between the top and bottom face 117, 118 of the cartridge 110.

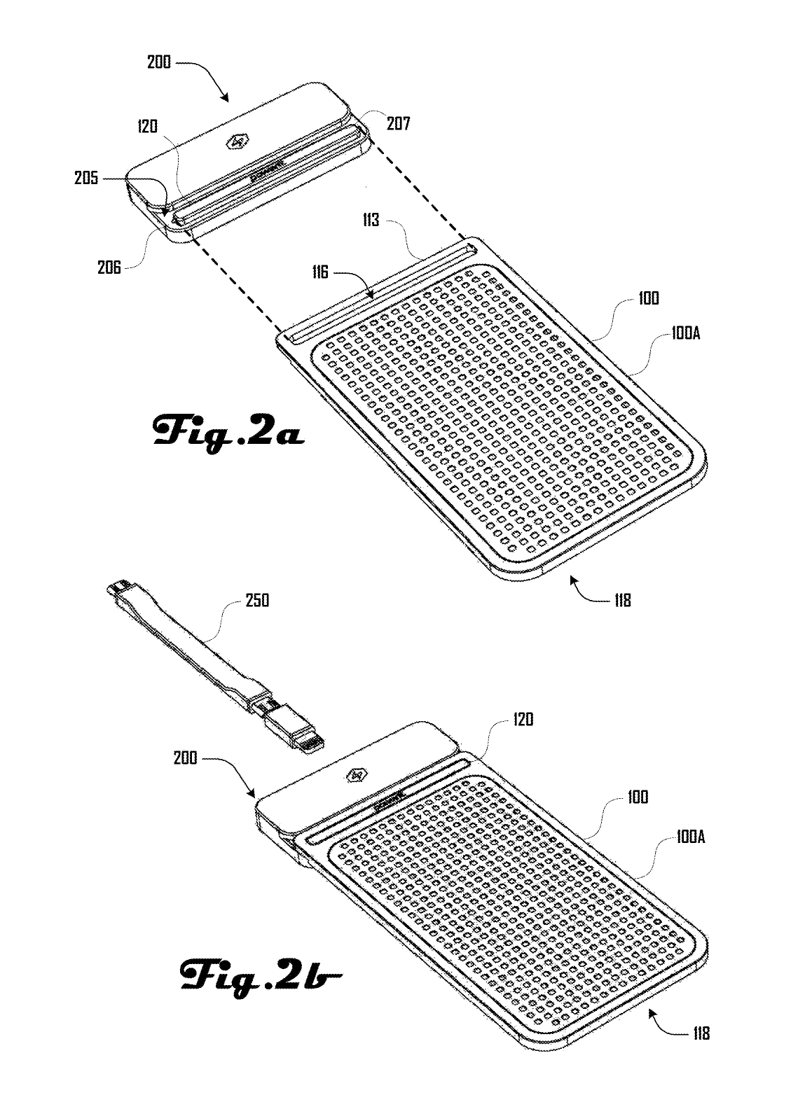

In various embodiments, the coupling slot 116 can correspond to a locking post 120 as illustrated in FIGS. 1b, 2a and 2b. Turning to FIG. 1b, the battery 100 can be configured to power various devices including a smartphone 125, which is shown disposed in a battery case 135, which can be configured to operably accept the battery 100A in a case tray 136 defined by the battery case 135. In other words, the battery 100A can be configured to snap into the tray 136 and around the locking post 120 to deliver power to the smartphone 125.

Accordingly, the example battery case 135 of FIG. 1b, can be operably connected to the smartphone 135 such that when the battery 100A is coupled with the case 135, electrical power generated by the battery 100A can be communicated to the smartphone 125 via the case 135 such that the battery 100A powers the smartphone in part or in whole. For example, in some embodiments, the smart phone can comprise one or more power source (e.g., a battery) and the battery 100A can provide additional power to the smart phone 135 and/or completely power the smartphone 135.

As discussed in more detail herein, in various embodiments, a power system can comprise a plurality of batteries 100 that are configured to removably couple with various devices (e.g., smartphones) to provide power to such devices. Such a system can be configured to provide power to such devices when one or more device power source is exhausted or depleted.

For example, when a user is running out of battery power on his smartphone 135, the user can attach a battery 100A to the battery case 135 on the smartphone 135 to provide power to the smartphone 135 to extend the operating life of the smartphone 135. Where a first battery 100A becomes depleted or exhausted, the user can swap a second battery 100A in place of the first battery 100A to further extend the operating life of the smartphone 135. Accordingly, by swapping out a plurality of batteries 100A on the case 135, the operating life of the smartphone 135 can be extended indefinitely, even if a battery of the smartphone 135 is depleted or exhausted.

Such a power system can be desirable because it can allow a user to continuously power a device without the necessity of charging a primary battery associated with the device. In some examples, a user can carry one or more battery 100 as a backup in case a primary battery associated with a device is depleted or exhausted and/or to replace depleted or exhausted backup batteries 100. In further examples, batteries 100 can be available at retail locations, from street vendors, via vending machines, via drone, via courier, or the like. In various examples, a user can identify, via an application, people and/or retailers that can provide the user with one or more battery 100. In some examples, batteries can be delivered to the user's location and/or the user can travel to a location where batteries are available.

Although a smartphone 135 is discussed as a device that can be powered by such a power system and/or battery 100, in further embodiments, any suitable device can be powered by a battery 100, including a tablet computer, a laptop computer, a smartwatch, a headset computer, a virtual reality system, a gaming device, a vehicle, a drone, an audio player, a body monitor, a work tool, or the like. Accordingly, in various embodiments, batteries 100 can take on various suitable sizes, shapes, and types. Some specific embodiments of batteries 100 having flat prismatic shape are described in the present disclosure, but should not be construed to be limiting on the wide variety of batteries 100 that are within the scope and spirit of the present invention.

Turning to FIGS. 2a and 2b, for example, the battery 100A of FIGS. 1a and 1b can be configured to operably couple with an adapter 200. The adapter 100 can be configured to directly interface with one or more devices to provide power to the device, or as shown in FIG. 2b, the adapter 200 can be configured to provide power to various devices via a power cord 250 that can couple with the adapter 200. In further examples, the adapter 200 can be configured to provide power to various devices wirelessly via inductive coupling, or the like.

In various examples, the adapter 200 can comprise a coupling rim 205 that comprises the locking post 120 disposed on a shelf 206. The shelf 206 can be perpendicular to a back wall 207. As illustrated in FIG. 2a, the coupling slot 116 can engage the coupling rim 205 and the top end 113 of the battery 100A can engage the back wall 207, with a portion of the rear face 118 of the battery 100A engaging the shelf 206.

FIGS. 1a, 1b, 2a and 2b illustrates an example battery 100A that is planar and rectangular with rounded corners and having a single elongated coupling slot 116 that extends parallel to the top end of the battery 100A. However, further embodiments can be of any suitable shape and size. Further embodiments can comprise a plurality of coupling slots 116, or a coupling slot 116 can be absent. Additionally, various suitable coupling structures can be present on a battery 100 in some embodiments.

In various embodiments, it can be desirable for devices, adapters and/or batteries of a power system to have complementary coupling structures. For example, in some embodiments, complementary coupling structures can provide for standardized couplings that can be the basis for a proprietary power system. In some embodiments, various complementary couplings can provide for batteries of a certain power profile (e.g. voltage and/or ampere output) to only be coupled with devices and/or adapters that are configured for that battery. In other words, batteries 100 having different power profiles can have different complementary couplings.

Additionally, in various embodiments, batteries 100 can be of any suitable battery type and may or may not be rechargeable. For example, a battery 100 can comprise a lead acid battery, a lithium ion battery, a nickel metal hydride battery, a zinc-air battery, or the like. The following discussion illustrates some examples of zinc-air batteries in accordance with various embodiments, but such disclosure should not be construed to be limiting on the many types of batteries that are within the scope and spirit of the present invention.

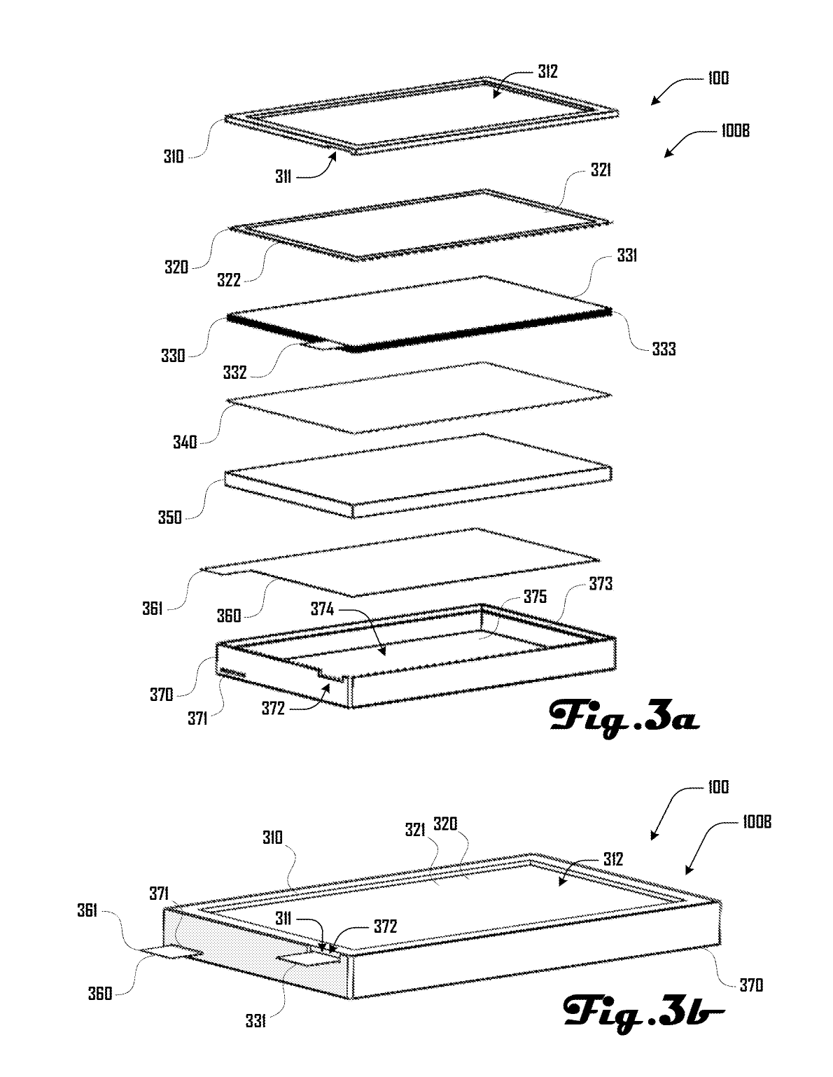

FIGS. 3a and 3b illustrate a battery 100 in accordance with one example embodiment 100B. The battery 100B is shown comprising a plurality of layered elements including a frame 310, a barrier 320, a cathode 330, a separator 340, a zinc layer 350, an anode collector 360, and a can 370.

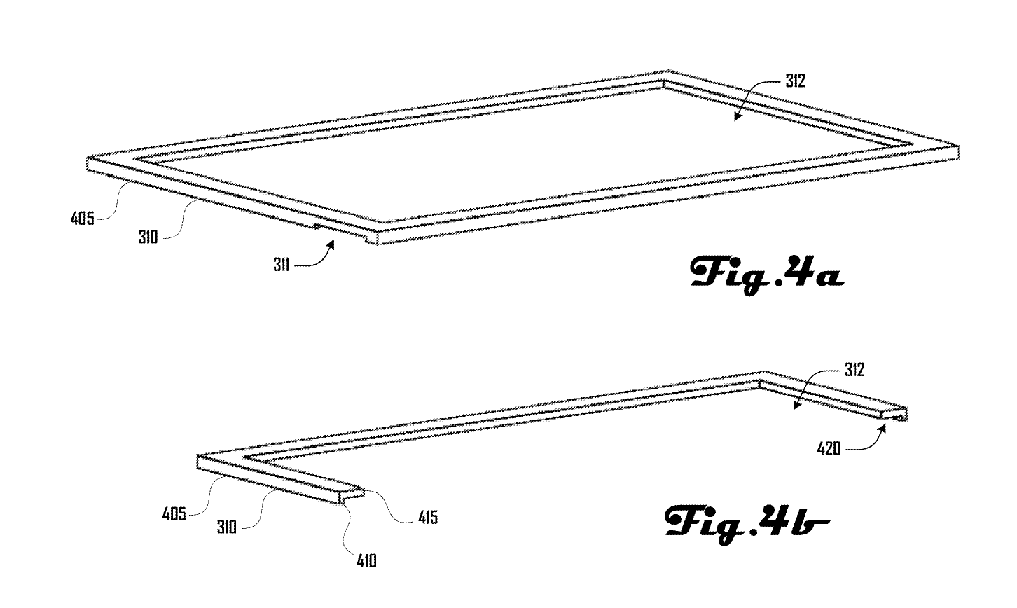

As illustrated in FIGS. 3a, 3b, 4a, 4b and 6 the frame 310 can comprise a cathode exit 311 defined by an outer wall 405 of the frame 310. In this example, as shown in the cross sectional view of FIG. 4b, the frame 310 can have an L-shaped cross section defined by an outer wall lip 410 that extends perpendicularly to a flange portion 415 that extends into and defines an orifice 312. The lip 410 and flange portion 415 can define a notch 420. The frame can comprise various suitable materials, including plastics such as polypropylene (PP), or the like. The frame 310 can be made in any suitable way, including injection molding, or the like.

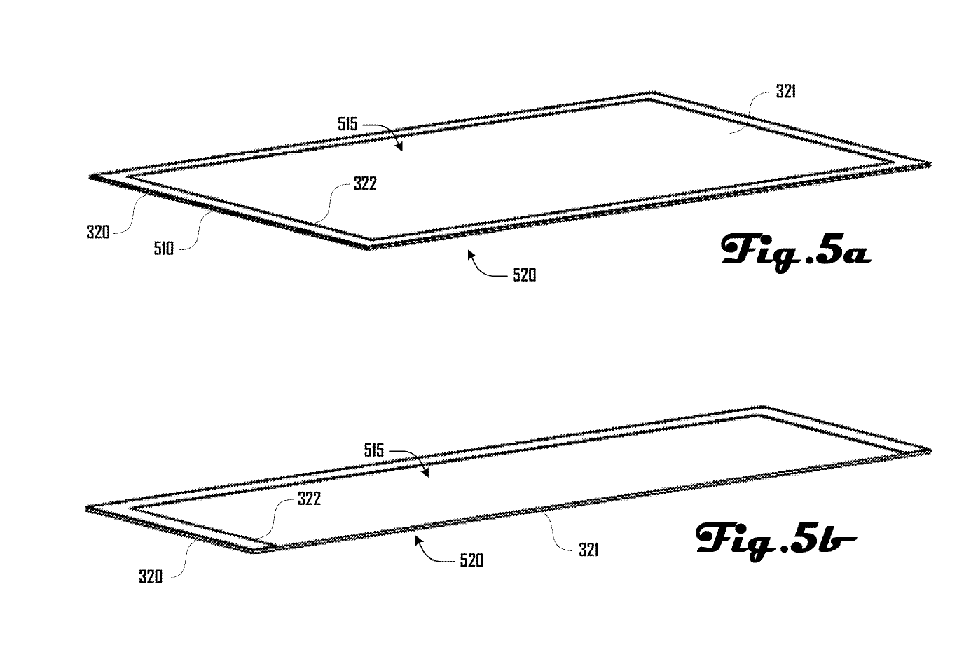

As illustrated in FIGS. 3a, 3b, 5a, 5b and 6, the barrier 320 can comprise a planar barrier sheet 321 having an adhesive 322 disposed about the edge 510 of a first face 515 of the barrier sheet 321. The barrier sheet 321 can comprise various suitable materials in various embodiments. In some embodiments, it can be desirable for the barrier sheet to comprise a material that is not liquid transmissive, but is gas transmissive. In other words, in some embodiments, the barrier sheet 321 can allow various gasses to pass through the barrier sheet 321 (e.g., between a first and second face 515, 520), but prevent liquids such as water from passing through the barrier sheet 321. As discussed in more detail herein, a gas transmissive barrier sheet 321 can be desirable because it can provide for functioning of the battery 100B by allowing various gasses to contact internal portions of the battery 100B to generate an electrical current. In some preferred embodiments, the barrier sheet 321 can comprise polytetrafluoroethylene (PTFE), ePTFE (proprietary polytetrafluoroethylene by W. L. Gore & Associates), and the like.

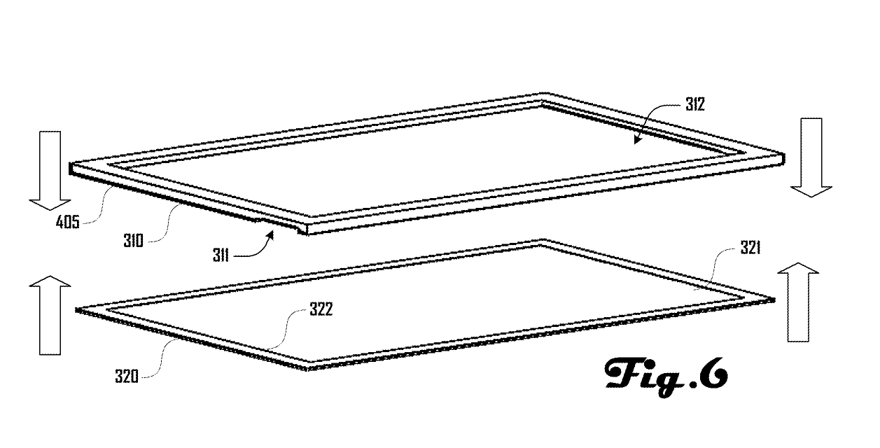

The adhesive 322 can comprise any suitable adhesive, including a glue, wax, epoxy, acrylic, silicone, rubber, VHB (3M, Inc.) or the like. For example, in one preferred embodiment, the adhesive 322 can comprise a pressure sensitive adhesive (PSA) or epoxy. As illustrated in FIG. 6, the barrier 320 can be configured to reside within the notch 420 defined by the frame 310. Additionally, the adhesive 322 can be configured to couple with the notch 320 via the lip 410 and/or flange portion 415 that define the notch 320. In some embodiments, a width of the adhesive 322 can correspond to a width of the flange portion 415, such that the adhesive does not substantially extend into the orifice 312 defined by the frame 310.

Additionally, in various embodiments, a thickness of the adhesive 322 and barrier sheet 321 can correspond to the cathode exit 311 defined by the outer wall 405 of the frame 310. For example, the thickness of the adhesive 322 and barrier sheet 321 can allow the adhesive 322 and barrier sheet 321 to reside within the notch 320 of the frame 310, without the adhesive 322 and barrier sheet 321 obstructing the cathode exit 311. In further embodiments, the barrier sheet 321 can be coupled to the frame 310 via an ultrasonic weld or other suitable coupling method.

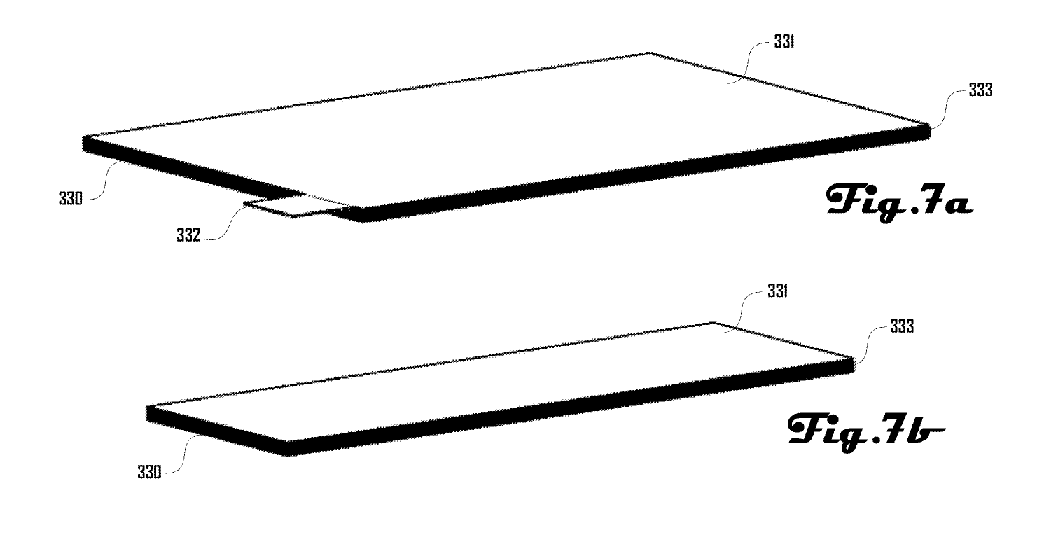

As illustrated in FIGS. 3a, 3b, 7a and 7b the cathode 330 can comprise a cathode collector plate 331 that includes a cathode terminal 332 and a cathode puck 333. In various embodiments, the cathode collector plate 331 can comprise any suitable metal or other conductive material. For example, in one preferred embodiment, the cathode collector plate 331 can comprise nickel. The cathode collector plate 331 can be in various suitable configurations and formed in various suitable ways in accordance with various embodiments. For example, in some embodiments, the cathode collector plate 331 can comprise a mesh that is configured to allow gas, fluid or other matter to pass through the collector plate 331 and contact the cathode puck 333. For example, in various embodiments, having a mesh collector plate 331 can be desirable so that air can reach the cathode puck 333 to facilitate a chemical reaction for generating electrical current.

The cathode puck 333 can comprise various suitable materials in various embodiments. For example, in one preferred embodiment, the cathode puck 333 can comprise carbon, manganese, and polytetrafluoroethylene (PTFE). In another preferred embodiment, the cathode puck 333 can comprise catalytic carbon manganese dioxide.

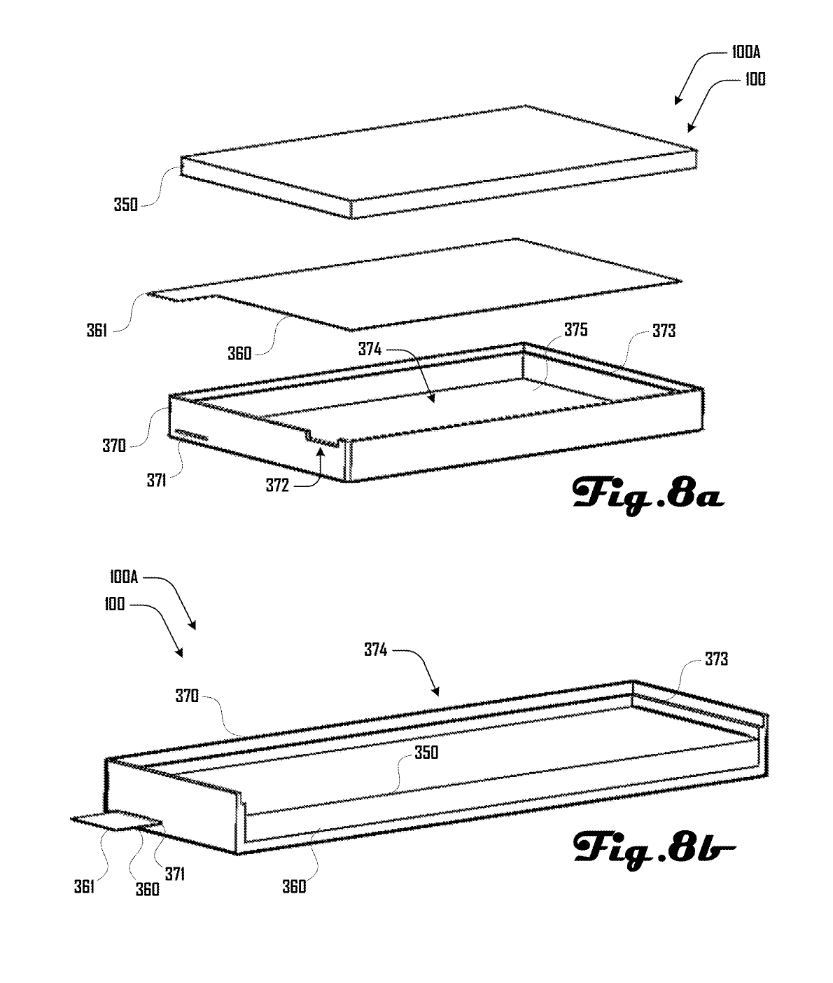

As illustrated in FIGS. 3a, 3b, 8a and 8b the battery 100B can comprise a zinc layer 350, an anode collector 360, and a can 370. FIGS. 3a and 8a illustrate an exploded view of the zinc layer 350, anode collector 360, and can 370 and FIG. 8b illustrates a cross sectional view of the zinc layer 350, anode collector 360, and can 370 in an assembled configuration. As shown in FIG. 8b, the anode collector 360 can be disposed within a tray 374 of the can 370 and can engage a base 375 of the can 370. The anode collector 360 can comprise an anode terminal 361, which can extend through an anode terminal slot 371 defined by the can 370. The zinc layer 350 can be disposed within the tray 374 of the can 370 over the anode collector 360.

In various examples, the zinc layer 350 can comprise a zinc slurry. For example, in one embodiment, the zinc layer 350 can comprise a semiliquid mixture of zinc particles suspended in potassium hydroxide or other suitable liquid. The anode collector 360 can comprise various suitable materials, including conductive materials such as metals. For example, in one preferred embodiment, the anode collector 360 can comprise brass.

The separator 340 (FIG. 3a) can be disposed over the zinc layer 350 in the tray 374 of the can 370. The separator 340 can comprise various suitable materials. The separator 340 can be rigid or flexible in some embodiments. Additionally, in some embodiments, the separator 340 can be fluid, gas and/or liquid permeable, semi-permeable or non-permeable. In various embodiments, it can be desirable to select a material for the separator 340 that is thin and wets well. In some embodiments, the separator can comprise a fabric, paper, or the like that can comprise non-woven wood pulp and/or synthetic fibers which may or may not be reinforced with a binder. For example, in one preferred embodiment, the separator 340 can comprise a KimWipe Wiper (Kimberly-Clark Professional, Inc.).

As illustrated in exploded view of FIG. 3a, the cathode 330 can be layered on the separator 340, with the frame 310 and barrier 320 layered on the cathode 330. The cathode terminal 332 can extend through the cathode exit 311 defined by an outer wall 405 and a cathode slot defined by the can 370. In various embodiments, the frame 310 can be configured to engage a shelf 373 defined by can 370 such that a top face of the frame 310 is parallel to a top face of a rim of the can 370. The frame 310 can be coupled to the can via a weld, adhesive, friction fit, or other suitable coupling method. An example assembled battery 100B is illustrated in FIG. 3b.

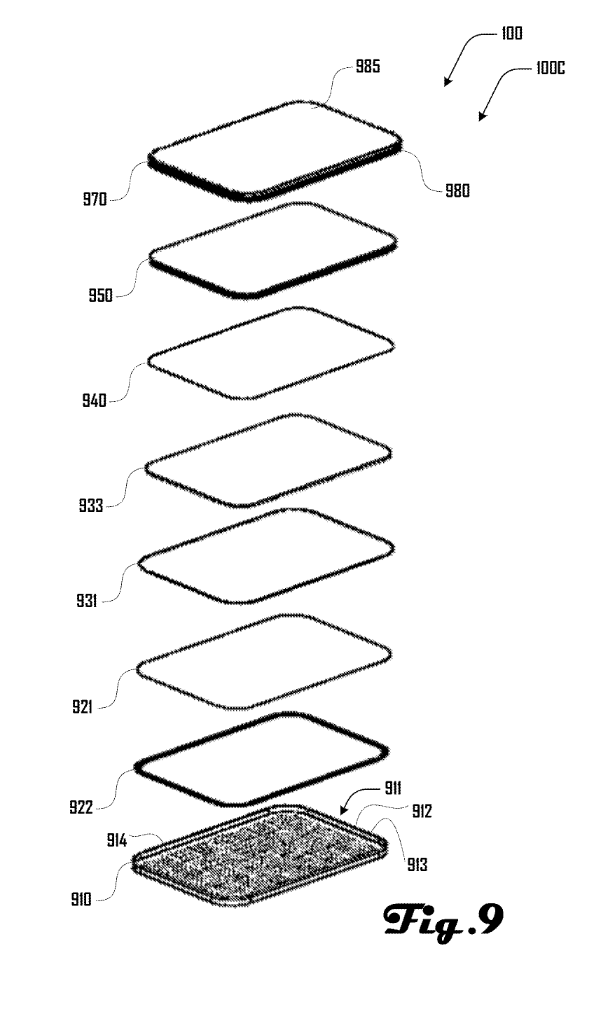

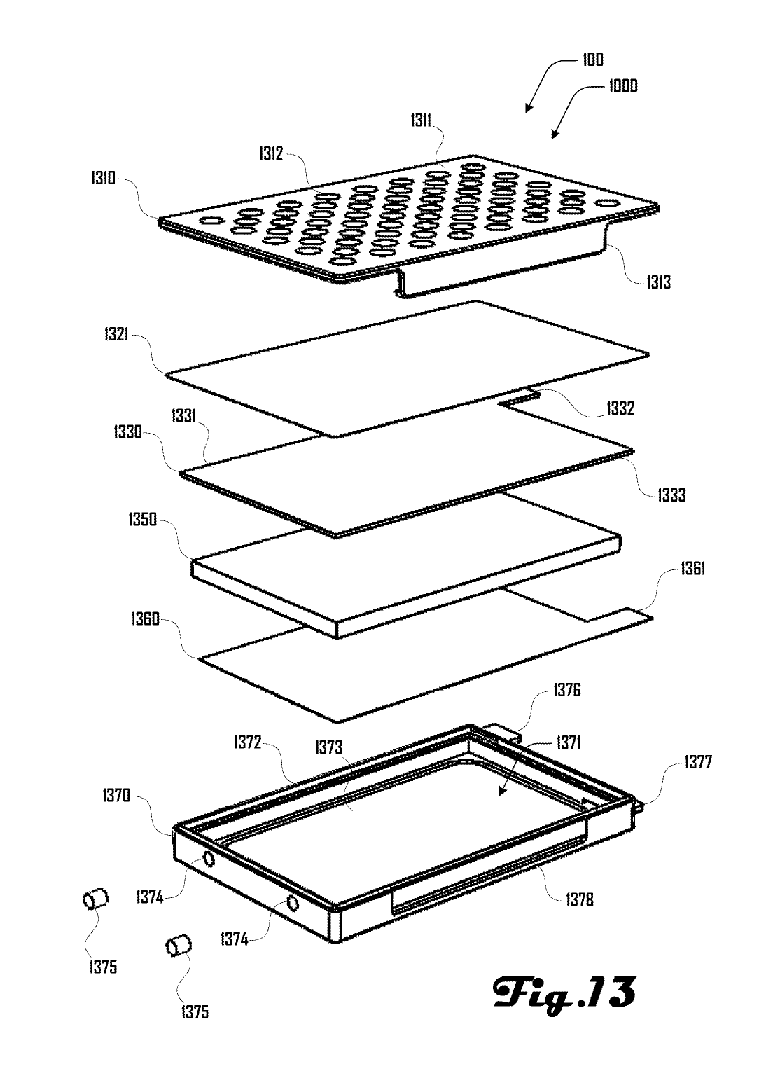

FIGS. 9-12 illustrate a battery 100 in accordance with another embodiment 100C. As illustrated in FIG. 9, the battery 100C can comprise a cathode can 910 that comprises a tray 911 defined by a rim 912 and a base 913 of the tray 910. As illustrated in FIGS. 9 and 13, in some embodiments, the base 913 of the cathode can 910 can comprise a plurality of ports or holes 914 that extend through the base 913.

A barrier sheet 921 can be coupled to the base 913 of the cathode can 910 via an adhesive 922. In some examples, the adhesive 922 and/or barrier sheet 921 can comprise any of the materials or be configured like the adhesive 322 and barrier sheet 321 discussed above. For example, in one embodiment, the barrier sheet 921 can comprise ePTFE and the adhesive 922 can comprise an epoxy or pressure sensitive adhesive.

A cathode collector 931 can be positioned over the barrier sheet 921 and a cathode puck 933 can be positioned over the cathode collector. In some embodiments, the cathode collector 931 and/or cathode puck 933 can comprise any of the materials or be configured like the cathode collector 331 and/or cathode puck 333 discussed above. For example, the cathode collector 931 can comprise a nickel mesh and the cathode puck 933 can comprise carbon, manganese, and/or polytetrafluoroethylene (PTFE). In another example, the cathode puck 933 can comprise catalytic carbon manganese dioxide.

A separator 940 can be positioned over the cathode puck 933 and a zinc layer 950 can be positioned over the separator 940. In some embodiments, the separator 940 and/or a zinc layer 950 can comprise any of the materials or be configured like the separator 340 or zinc layer 350 discussed above. For example, the separator 940 can comprise a KimWipe material and the zinc layer 940 can comprise a zinc slurry having zinc particles suspended in a liquid such as potassium hydroxide, or the like.

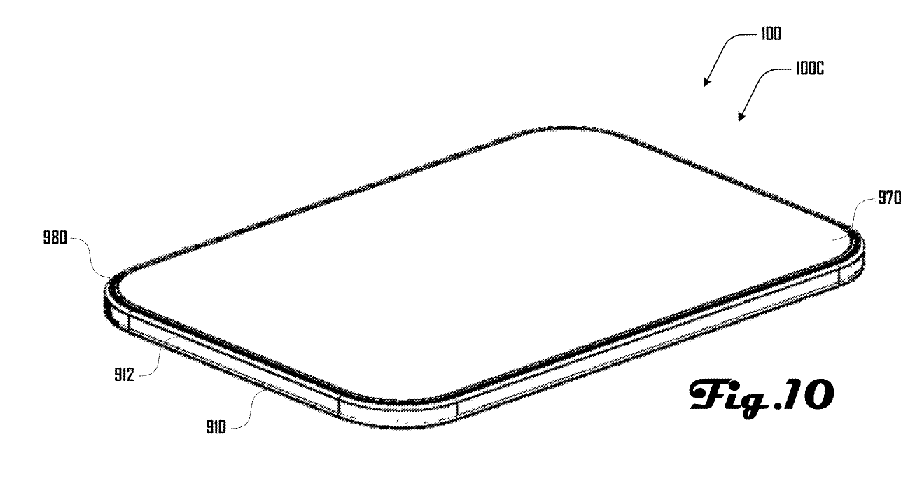

An anode cap 970 can be positioned over the zinc layer 950 and engage a portion of the rim 912 of the can 910 within the tray 911. For example, the anode cap 970 can comprise a gasket 980 that surrounds an edge of an anode body 985 of the anode cap 970, and the gasket can engage a portion of the rim 912 of the can 910 within the tray 911 via friction fit, or the like. In various embodiments, the anode body 985 can comprise any suitable material including a metal. For example, the anode body 985 can comprise nickel, stainless steel plated with nickel and the like. The gasket 980 can comprise any suitable material including rubber, silicone, a plastic, or the like. FIG. 10 illustrates an example perspective view of an assembled battery 100B, including the anode cap 970 engaging the rim 912 can 910 via the gasket 980.

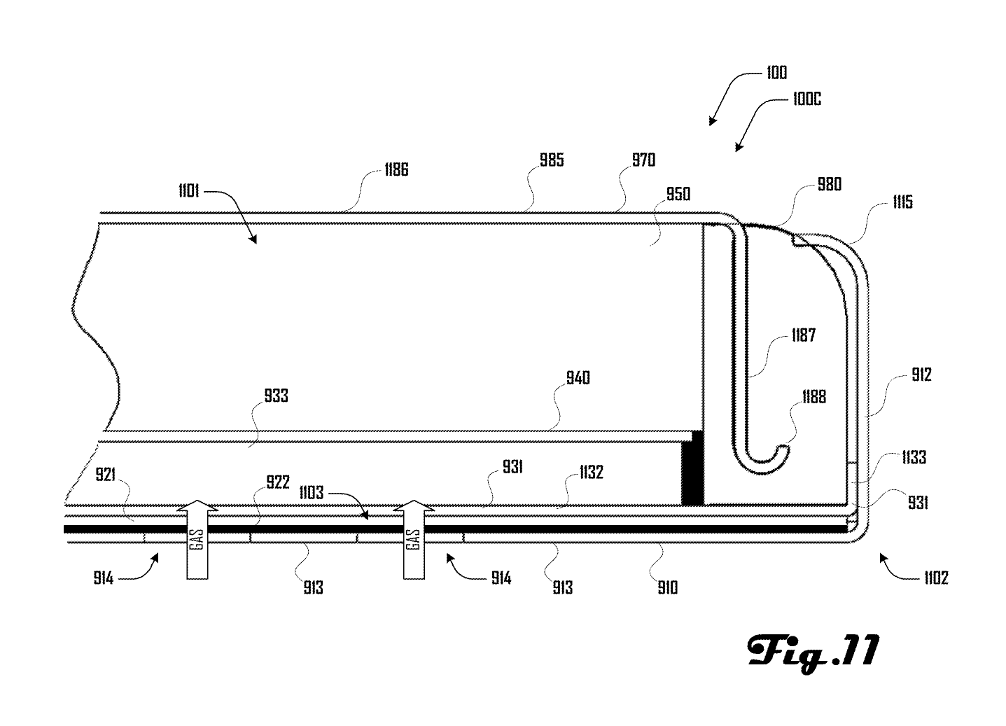

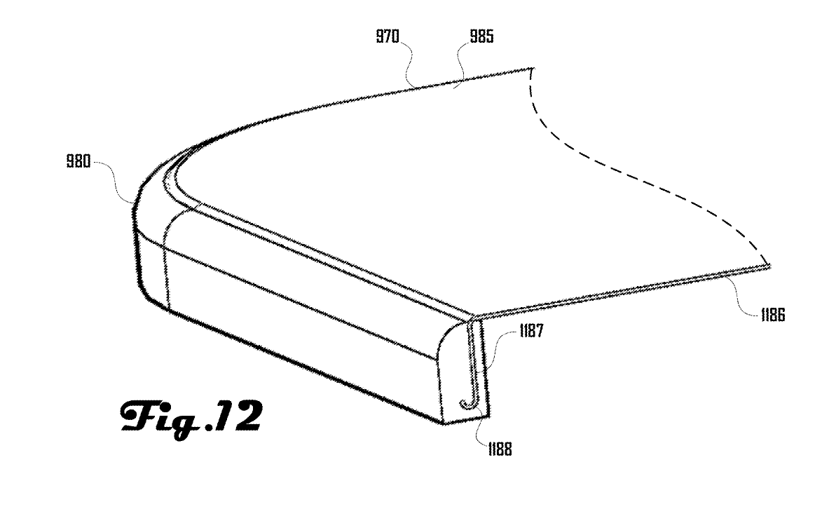

FIG. 11 illustrates an example cross section of the battery 100C, which shows a top outer layer defined by the anode body 985 of the anode cap 970. The anode body 985 is shown in FIGS. 11 and 12 comprising a planar cap top 1186 with rim 1187 extending away from and perpendicular to the cap top 1186, the rim 1187 is shown over-molded with the gasket 980 and comprising a terminal curl 1188 that can serve to fix the gasket 980 in place over the rim 1188.

The cathode can 910 engage the gasket 980 via a lip 1115 defined by the rim 912 of the cathode can 910. The gasket 980 further extends downward and engages the cathode collector 931 along a portion of a cathode collector base 1132 and a cathode collector rim 1133 that extends upward and perpendicularly away from the cathode collector base 1132. The planar cap top 1186, the gasket 980 and the cathode collector 931 define a cavity 1101, wherein the zinc layer 950, the separator 940, and cathode puck 933 are disposed. More specifically, the zinc layer 950 is disposed on the separator 940, and the separator is disposed on the cathode puck 933, which is disposed on the collector base 1132 of the cathode collector 931.

The cathode collector 931 engages the rim 912 of the cathode can 910 to collectively form an anode 1102. An anode cavity 1103 is defined between the cathode collector base 1132 and the cathode can base 913. The barrier 921 and adhesive 922 are disposed within the anode cavity 1103 with the adhesive 922 coupling an edge of the barrier 921. In various embodiments, the cathode collector 931 can apply pressure to the barrier 921 and adhesive 922, which can be desirable for generating a better seal between the barrier 921, adhesive 922, and cathode can 910.

As illustrated in FIG. 11, in various embodiments, gas can penetrate the battery 100C via the one or more ports 914 defined by the can base 913 and reach the cathode puck 933. Allowing gas, such as air or the like, to reach the cathode puck 933 can be desirable because it can provide for a chemical reaction between the gas and the cathode puck 933, which can facilitate generation of an electrical current.

As discussed herein and as illustrated in FIG. 9 the adhesive 922 can be disposed on an outer edge of the barrier 921, which exposes a portion of the barrier 921 to gas entering the ports 914. The barrier 921 can be configured to be gas permeable, which can allow the gas to pass through the barrier 921. In some embodiments, the barrier can be configured to be non-transmissive for liquids, solids and the like. Additionally, the cathode collector 931 can comprise a mesh configuration, or the like, which can provide a plurality of passages through the cathode collector 931. Accordingly, gas can pass through the cathode collector 931 and contact the cathode puck 933 to facilitate a chemical reaction to generate electrical current.

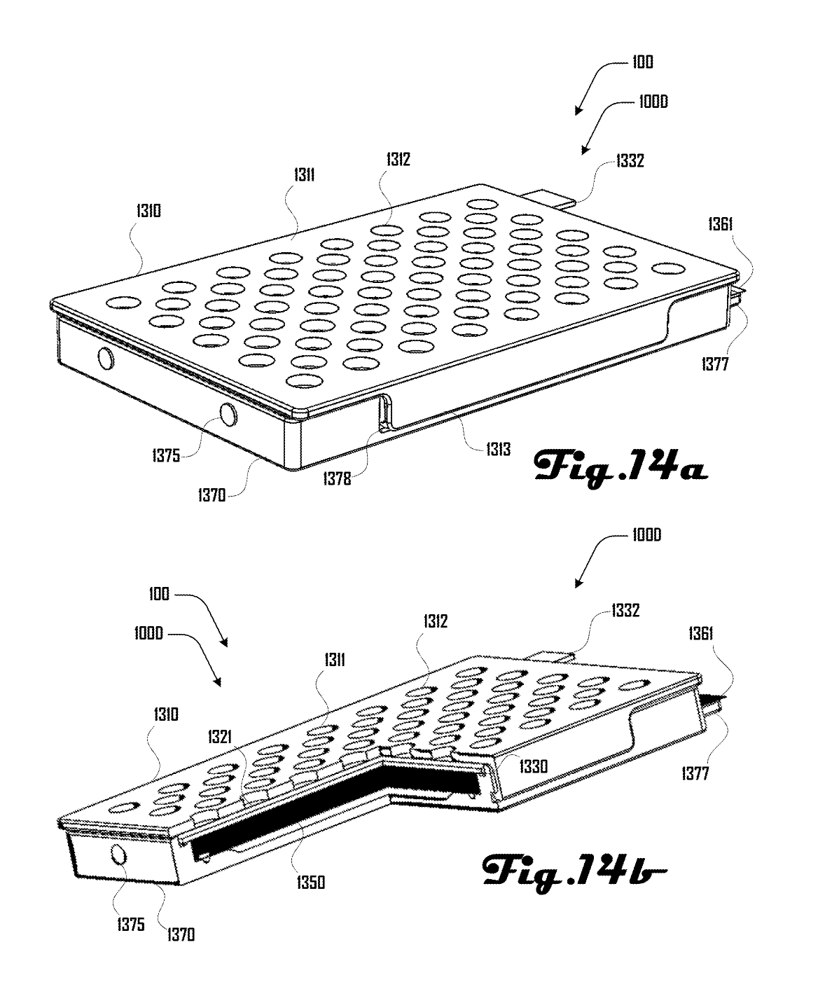

FIGS. 13, 14a and 14b illustrate another embodiment of a battery 100 in accordance with another embodiment 100D. The battery 100D comprises a chassis 1370, that comprises a tray 1371 defined by a rim 1372 and a base 1373 of the tray 1371. The chassis 1370 can also comprise one or more fill port 1374, in which a respective plug 1375 can reside. The chassis 1370 can also comprise respective cathode an anode terminal ports 1376, 1377 and a coupling slot.

The battery 100D can also comprise an anode collector 1360 that includes an anode terminal 1360. The anode collector 1360 can reside at the base 1373 of the chassis 1370 within the tray 1371, with the anode terminal 1360 extending into and/or through the anode terminal port 1377. In some embodiments, the anode collector 1360 can comprise any of the materials or be configured like the anode collector 360 discussed above and illustrated in FIG. 3. For example, in one preferred embodiment, the anode collector 1360 can comprise brass.

A zinc layer 950 can be positioned over the anode collector 1360. In some embodiments, zinc layer 950 can comprise any of the materials or be configured like zinc layers 350, 950 discussed above. For example, the zinc layer can comprise a zinc slurry having zinc particles suspended in a liquid such as potassium hydroxide, or the like.

A cathode 1330 can be positioned over the zinc layer 950 and can comprise a cathode collector plate 1331 that includes a cathode terminal 1332 and a cathode puck 1333. The cathode 1330 can reside within the tray 1373 of the chassis 1370 with the cathode terminal 1332 extending through the cathode terminal port 1376.

In various embodiments, the cathode collector plate 1331 can comprise any suitable metal or other conductive material. For example, in one preferred embodiment, the cathode collector plate 1331 can comprise nickel. The cathode collector plate 1331 can be in various suitable configurations and formed in various suitable ways in accordance with various embodiments. For example, in some embodiments, the cathode collector plate 1331 can comprise a mesh that is configured to allow gas, fluid or other matter to pass through the collector plate 1331 and contact the cathode puck 1333. For example, in various embodiments, having a mesh collector plate 1331 can be desirable so that air can reach the cathode puck 1333 to facilitate a chemical reaction for generating electrical current.

The cathode puck 1333 can comprise various suitable materials including carbon, manganese, and/or polytetrafluoroethylene (PTFE). For example, in one embodiment the cathode puck 1333 can comprise catalytic carbon manganese dioxide. In some embodiments the cathode puck 1333 can comprise a wetting or separator layer, which can comprise a fabric, paper, or the like. For example, in some embodiments, the cathode puck 1333 can comprise a separator 340, 940 as discussed above, and such a separator can be disposed between the cathode puck 1333 and the zinc layer 1350.

A barrier sheet 921 can be positioned over the cathode puck 1333. In some examples, the barrier sheet 921 can comprise any of the materials or be configured like the barrier sheet 321, 921 discussed above. For example, in one embodiment, the barrier sheet 1321 can comprise ePTFE or PTFE.

A cover 1310 can be positioned over the barrier sheet 1321 and include a top 1311 that defines a plurality of holes or ports 1312 that extend through the top 1311. The cover 1310 can further comprise a pair of arms 1313 that are configured to couple with respective coupling slots 1387 defined by the rim 1372 of the chassis 1370. The cover 1310 can be configured to seal the elements between the chassis base 1373 and cover 1310 within the tray 1371 of the chassis 1370. The cover 1310 and/or chassis 1370 can comprise any suitable materials including a plastic, metal, or the like.

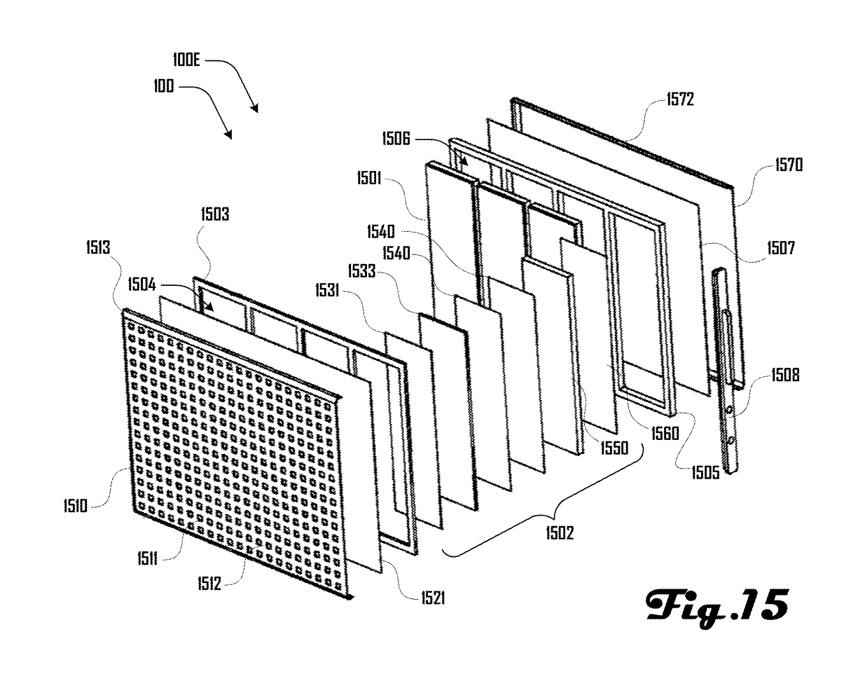

In some embodiments, a battery 100 can comprise a plurality of battery cells in contrast to a single battery cell as described in embodiments 100B-D. For example, FIG. 15 illustrates another embodiment 100E of a battery 100 that comprises a plurality of battery cells 1501 that comprise a plurality of battery layers 1502. The cells 1501 can comprise a configuration like any of the batteries described above in embodiments 100B-D.

For example, the plurality of layers 1502 of the cells 1501 can include a cathode collector 1531, a cathode puck 1533, one or more separator 1540, a zinc layer 1550, and an anode collector 1560. In the example of FIG. 15, the battery 100E includes four cells 1501; however, in further embodiments, and suitable plurality of cells or a single cell can be implemented. For example, some embodiments can have one, two, three, five, six, seven, eight, nine or ten cells.

The cells 1501 can be configured to reside within slots 1504, 1506 defined by a respective reinforcing frame 1503 and cell walls 1505. The cells 1501, frame 1503 and cell walls 1505 can be surrounded by a barrier sheet 1521, a cell backing 1507, a chassis 1570, one or more cap 1508, and a cover 1510. The cover 1510 can be positioned over the barrier sheet 1521 and include a top 1511 that defines a plurality of holes or ports 1512 that extend through the top 1511. The cover 1510 can further comprise a pair of arms 1513 that are configured to couple with a rim 1572 of the chassis 1570. The cover 1510 can be configured to seal the cells 1501 between the chassis 1570 and cover 1310.

The chemical and hardware elements of batteries 100 can comprise any suitable configuration that provides for generation of an electrical current. Additionally, while the example, of a zinc-air battery is used herein, it should be clear that alternative battery types, chemistries, and battery configurations are also within the scope and spirit of the present disclosure.

In various embodiments, a zinc layer 350, 950, 1350, 1550 can include various suitable compositions. For example, a zinc layer 350, 950, 1350, 1550 can comprise a slurry or gel that includes of a blend of amalgamated zinc grains and potassium hydroxide. In one example, a potassium hydroxide electrolyte gel can include 18 M-Ohm deionized water; zinc grains doped with indium and/or bismuth (e.g., Grillo Werk Aktiengesellschaft, #000010-600376); carboxymethylcellulose and sodium salt (e.g., High Viscosity, Sigma CAS #9004-32-4); and potassium hydroxide 90%.

In one example, a zinc slurry or gel can be made by preparing a solution of 11 M potassium hydroxide and 1.6% wt carboxymethylcellulose and mixing 0.69% wt powdered zinc with 0.31% wt of the prepared solution. Further embodiments can employ suitable compositions, system and methods from U.S. Patent Publication US 2011/0123902 of U.S. application Ser. No. 12/919,214 filed May 26, 2011, which is hereby incorporated by reference in its entirety and for all purposes.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A zinc-air battery comprising:
a gas-permeable barrier sheet first layer;
a cathode collector second layer disposed abutting the gas-permeable barrier sheet first layer, the cathode collector second layer comprising a gas-permeable nickel mesh;
a cathode puck third layer disposed abutting the cathode collector second layer, the cathode puck third layer comprising carbon manganese dioxide;
a separator fourth layer disposed abutting the cathode puck third layer;
a zinc slurry fifth layer disposed abutting the separator fourth layer, the zinc fifth layer comprising a zinc slurry including zinc particles suspended in a liquid;
an anode collector sixth layer disposed abutting the zinc slurry fifth layer, the anode collector sixth layer comprising brass; and
a housing surrounding the first, second, third, fourth, fifth and sixth layer and comprising a gas-permeable housing first end disposed abutting the barrier sheet first layer.

2. The zinc-air battery of claim 1, wherein the gas-permeable barrier sheet first layer is liquid-impermeable.

3. The zinc-air battery of claim 1, wherein the anode collector sixth layer comprises an anode collector terminal that extends through the housing and wherein the cathode collector second layer comprises a cathode collector terminal that extends through the housing.

4. The zinc-air battery of claim 1, configured for gas to travel through the gas-permeable housing first end, through the gas-permeable barrier sheet first layer, through a gas-permeable nickel mesh of cathode collector second layer and interact cathode puck third layer to generate a chemical reaction.

5. The zinc-air battery of claim 1, wherein the zinc-air battery is configured to operably couple with a smartphone via the anode collector sixth layer and cathode collector second layer and provide sufficient electrical current to operably power the smartphone.

6. A zinc-air battery comprising:
a gas-permeable barrier sheet first layer;
a cathode collector second layer disposed facing the gas-permeable barrier sheet first layer,
a cathode puck third layer disposed facing the cathode collector second layer;
a separator fourth layer disposed facing the cathode puck third layer;
a zinc fifth layer disposed facing the separator fourth layer;
an anode collector sixth layer disposed facing the zinc fifth layer; and
a housing surrounding at least the first, second, third, fourth, and fifth layers and comprising a gas-permeable housing first end disposed facing the barrier sheet first layer.

7. The zinc-air battery of claim 6, wherein the cathode collector second layer comprises a gas-permeable nickel mesh.

8. The zinc-air battery of claim 6, wherein the cathode puck third layer comprises carbon manganese dioxide.

9. The zinc-air battery of claim 6, wherein the zinc fifth layer comprises zinc particles disposed in potassium hydroxide.

10. The zinc-air battery of claim 6, wherein the anode collector sixth layer comprises brass.

11. The zinc-air battery of claim 6, wherein the separator fourth layer comprises non-woven wood pulp.

12. The zinc-air battery of claim 6, wherein the gas-permeable barrier sheet first layer comprises polytetrafluoroethylene.

13. The zinc-air battery of claim 6, wherein the barrier sheet first layer is coupled to the housing first end with an adhesive.

14. The zinc-air battery of claim 6, wherein the housing further comprises a housing second end disposed facing the anode collector sixth layer.

15. The zinc-air battery of claim 6, wherein the housing comprises at least a portion of the anode collector sixth layer.

16. The zinc-air battery of claim 6, wherein the anode collector sixth layer further comprises an anode collector rim extending away from and perpendicular to an anode collector cap top, the anode collector rim surrounding a peripheral portion of at least the zinc fifth layer and, the separator fourth layer, and the cathode puck third layer.

17. The zinc-air battery of claim 6, wherein the gas-permeable barrier sheet first layer is liquid-impermeable.

18. The zinc-air battery of claim 6, wherein the anode collector sixth layer comprises an anode collector terminal that extends through the housing and wherein the cathode collector second layer comprises a cathode collector terminal that extends through the housing.

19. The zinc-air battery of claim 6, configured for gas to travel through the gas-permeable housing first end, through the gas-permeable barrier sheet first layer, through a gas-permeable nickel mesh of cathode collector second layer and interact the cathode puck third layer to generate a chemical reaction.

20. The zinc-air battery of claim 6, wherein the zinc-air battery is configured to operably couple with a smartphone via the anode collector sixth layer and cathode collector second layer and provide sufficient electrical current to operably power the smartphone.
